(19) United States
(12) Patent Application Publication
(10) Pub. No.: US 2006/0088280 A1
(43) Pub. Date: Apr. 27, 2006

(54) Remote controller for use with digital recording and reproducing apparatus

(75) Inventor: Chia-Hsiang Lin, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/254,979

(22) Filed: Oct. 20, 2005

(30) Foreign Application Priority Data
Oct. 22, 2004 (TW) 093132235

(51) Int. Cl. H04N 5/781

(52) U.S. Cl. 386/46; 386/125

(57) ABSTRACT

A remote controller includes at least a button and an audio prompt generator is disclosed. The button is used for cooperating with a digital recording/reproducing apparatus. The audio prompt generator generates an audio prompt in response to a triggering operation done on the button.

### FIELD OF THE INVENTION

The present invention relates to an auxiliary operation interface, and more particularly to an auxiliary operation interface and a method for facilitating a user to operate a digital recording/reproducing apparatus.

### BACKGROUND OF THE INVENTION

Referring to FIG. 1, a functional block diagram of a typical digital recording/reproducing apparatus is shown. A digital recording/reproducing apparatus 10, for example a DVD recorder, is used to record video data into a recordable disc or reproduce video data from a readable disc. Nowadays, the digital recording/reproducing apparatus can be used with various kinds of electrical appliances to record video data from various sources. For example, the analog video signals received from the TV tuner 11 are transmitted to the control circuit 16 to be converted into digital data in a specified format such as MPEG. The digital data in the MPEG format are then recorded into a recordable disc loaded in the disc burner 17 of the DVD recorder 10. Likewise, the analog video signals received from the video cassette recorder (VCR) 12, the DVD player 13, or the digital video signals received from the digital video (DV) camera 14 can also be converted into digital data in a specified format such as MPEG by the control circuit 16 to be recorded into the recordable disc 15.

Referring to FIG. 2, a functional block diagram of another digital recording/reproducing apparatus is shown. The digital recording/reproducing apparatus 100 comprises a disc burner 102, a control circuit 106 and a digital data storage device such as a hard disc drive 101. The signals received from the TV tuner 11, the VCR 12, the DVD player 13 or the DV camera 14 are firstly converted into digital data in a specified format such as MPEG by the control circuit 106. The MPEG digital data are then stored in the hard disc drive 101 in an editable manner. The edited digital data is then recorded into the recordable disc 15 by the disc burner 102. On the other hand, it is also possible to record the data previously stored in the disc 15 into the hard disc drive 101.

Since the digital recording/reproducing apparatus mentioned above exhibits functions of record and playback and generally has other extended uses, for example scheduled record, the operating interface for control of the digital recording/reproducing apparatus, such as a remote controller, would be quite complex. The complicated operating interface becomes hindrance from using the digital recording/reproducing apparatus, particularly for the elderly or uneducated users. Recently, a graphic-based user interface, so called as “easy guider”, was developed to make the control more user-friendly. For example, when an actuating button on a remote controller is pressed down, a comprehensible guiding menu consisting of several selective items is shown on the screen. Following the instructions shown on the screen, the user can navigate functions of the digital recording/reproducing apparatus by moving the cursor to the desired operation item on a step-by-step basis.

FIGS. 3(a), 3(b), 3(c), 3(d) and 3(e) schematically show various guiding menus sequentially displayed for guiding the user to control the digital recording/reproducing apparatus to execute the recording function. In the main menu of FIG. 3(a), items of playback, record, erase and finalize are provided for user's selection. In this case that a record function is to be executed, the term “Record” is selected by moving the highlight cursor to the desired visual key 31 on the screen with the up/down buttons of the remote controller and pushing the “Enter” button under this circumstance. Then, a sub-menu of FIG. 3(b) will be shown for further selection. In this sub-menu, the video source including TV, AV1, AV2, S-Video or DV is to be selected. If the TV video source is selected by moving the highlight cursor to the desired visual key 32 on the screen with the up/down buttons of the remote controller and the “Enter” button is pushed down under this circumstance, a further menu will be shown for the user to select the channel that is to be recorded, as shown in FIG. 3(c). By pushing the channel up/down buttons, the digits in the visual key 33 will change. After the desired channel is located, push “Enter” to enter next menu, as shown in FIG. 3(d), to select the recording quality and the recording period. For example, the HQ mode offers the highest resolution with highest bit rate. However, only 1 hour of video can be recorded in this mode. The SP mode has a lower bit rate, but the video quality is still very good. The video quality with the EP and SLP isn't nearly as good, but a lot of video data can be fit onto one disc in these modes. After the user selects the desired recording period/quality, e.g. 2 hrs/SP, via the visual key 34 and then pushes “Enter”, the frame as shown in FIG. 3(e) will be shown. In this menu, the recording operation is started upon the visual key 35 indicating the term “Go” is pushed.

The “easy guider” operating interface, although alleviating complexity problem by minimizing real buttons on the remote controller, is still not user-friendly enough. Since the text and graphic symbols shown on the screen is very simple, some users may have problem in realizing or memorizing the meaning of the visual keys or need to look it up in the handbook. Therefore, the operation of the easy guider needs to be further improved.

Furthermore, since the frame change on the screen is generally not as quick as the button-triggering operation, whether the button of the remote controller is successfully triggered is not perceptible and thus undesirable or excessive button-pushing may be done by the user. For example, in a case that a record function is to be executed and the highlight cursor is now in the “play” key, the user should move the highlight cursor to the desired visual key 31 on the screen by triggering the “down” button of the remote controller. Since the shift of the highlight cursor lags behind the triggering operation of the “down” button of the remote controller, the user may think that no effective triggering is performed and is likely to repeatedly trigger the “down” button of the remote controller. If these two triggering operations are both effective, the highlight cursor will be finally moved to the “erase” key 36. Once the “Enter” button of the remote controller is pushed, the digital recording/reproducing apparatus will regrettably execute the erasing function.

### SUMMARY OF THE INVENTION

The present invention provides an auxiliary operation interface of a digital recording/reproducing apparatus to help the user well understand what he can do under the displayed easy guider menu. The present invention also suggests how to facilitate a user to operate a digital recording/reproducing apparatus.

The present invention also provides a remote controller capable of confirming whether a button thereof is successfully triggered so as to prevent from executing a wrong function.

In accordance with a first aspect of the present invention, there is provided a remote controller for use with a digital recording/reproducing apparatus. The remote controller includes at least a button and an audio prompt generator. The button is used for cooperating with a digital recording/reproducing apparatus. The audio prompt generator generates an audio prompt in response to a triggering operation done on the button. Besides, a triggering signal could be issued to the audio prompt generator in response to the triggering operation, and the audio prompt generator generates the audio prompt in response to the triggering signal.

In an embodiment, the audio prompt generator includes a loudspeaker or a bee buzzer. The audio prompt generator could also include a sound output circuit for varying audio prompts with triggering signals.

In accordance with a second aspect of the present invention, there is provided a remote controller for use with a digital recording/reproducing apparatus. The remote controller includes a plurality of selection buttons, a confirmation button and an audio prompt generator. The plurality of selection buttons are used for cooperating with the digital recording/reproducing apparatus to select a targeting item. The confirmation button is used for having the digital recording/reproducing apparatus execute a selected function corresponding to the targeting item. The audio prompt generator generates an audio prompt in response to a triggering operation done on one of the selection buttons and confirmation button. In an embodiment, the audio prompt generator includes a loudspeaker or a bee buzzer.

In accordance with a third aspect of the present invention, there is provided an auxiliary operation interface for use with a digital recording/reproducing apparatus. The auxiliary operation interface includes a guiding menu, a first audio generator, and a remote controller. The guiding menu has a targeting item optionally triggered to have the digital recording/reproducing apparatus execute a selected function. The first audio prompt generator is enabled to generate a first audio prompt when the targeting item is triggered to enter the selected function. The remote controller includes a plurality of buttons and a second audio prompt generator. The plurality of buttons is utilized for manipulating the targeting item. The second audio prompt generator generates a second audio prompt when any of the buttons is pushed.

In an embodiment, the guiding menu is entered with a function button of the remote controller. The guising menu further has a plurality of selective items, and the selective function is entered by switching the targeting item to selectively lock one of the selective items by using the buttons of the remote controller. The targeting item can further be triggered with an enter button of the remote controller.

In an embodiment, the first audio prompt generator is enabled and disabled with a switching button set of the remote controller. The switching button set of the remote controller includes a single button or a combination of buttons.

In an embodiment, the second audio prompt generator includes a loudspeaker or a bee buzzer. The first audio prompt generator includes an audio process engine and/or a speech engine. The first audio prompt generator could include a flash memory or hard disc drive for storing a plurality of audio files. And the first audio prompt generator could be implemented by integrated circuits for generating the first audio prompt.

The above contents of the present invention will become more readily apparent to those ordinarily skilled in the art after reviewing the following detailed description and accompanying drawings, in which;

### BRIEF DESCRIPTION OF THE DRAWINGS

FIG. 1 is a functional block diagram illustrating the use of a conventional digital recording/reproducing apparatus with a plurality of external data sources;

FIG. 2 is a functional block diagram illustrating the use of another conventional digital recording/reproducing apparatus with a plurality of external data sources;

FIGS. 3(a), 3(b), 3(c), 3(d) and 3(e) are schematic diagrams showing a series of easy guider menu for executing a recording operation;

FIG. 4 is a functional block diagram illustrating a digital recording/reproducing apparatus using an auxiliary operation interface according to a preferred embodiment of the present invention;

FIG. 5 is a flowchart illustrating the operation of the auxiliary operation interface for facilitating a user to operate the digital recording/reproducing apparatus according to the present invention;

FIG. 6(a) is a functional block diagram illustrating the sequence of selectively enabling or disabling the sound effect and speech effect with a single push button according to the present invention;

FIG. 6(b) is a front view illustrating a remote controller for selectively enabling or disabling the sound effect and speech effect by pushing a combination of at least two buttons;

FIG. 6(c) is a front view illustrating a remote controller for selectively enabling or disabling the sound effect and speech effect by pushing respective exclusive buttons; and

FIG. 7 is a functional block diagram illustrating a remote controller for use with a digital recording/reproducing apparatus, which has the function of generating a sound prompt according to the present invention.

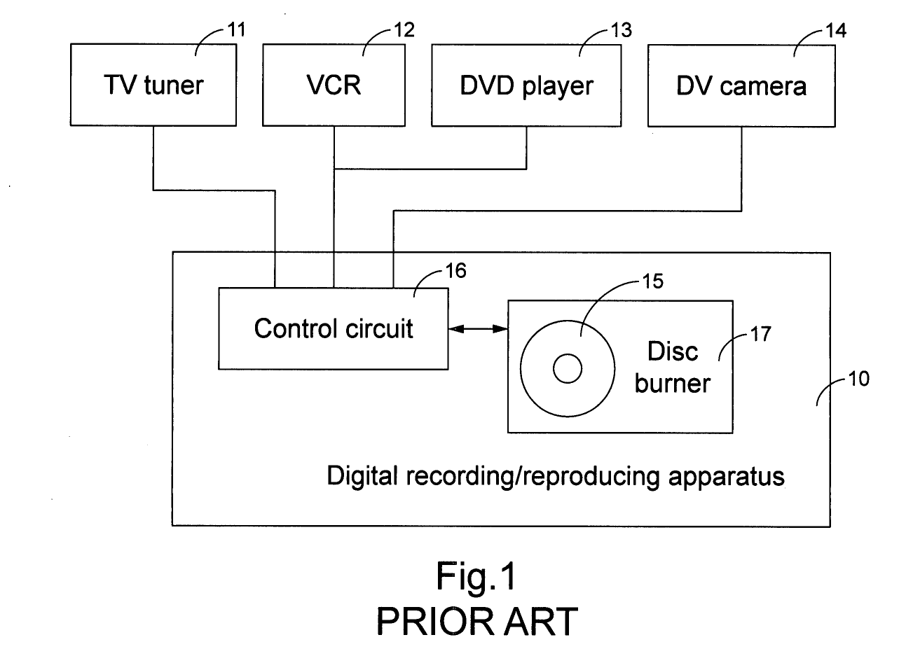

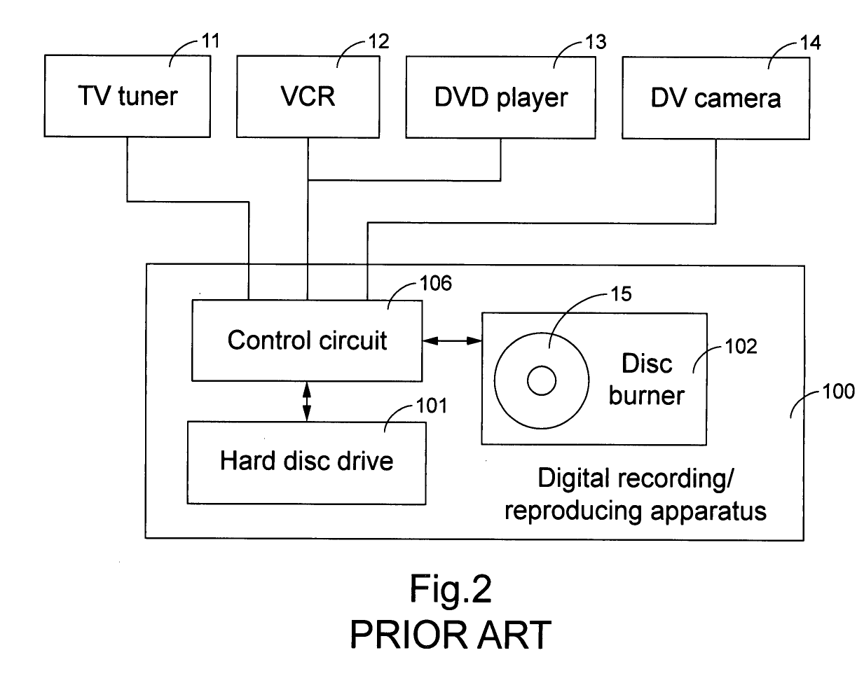

### DETAILED DESCRIPTION OF THE PREFERRED EMBODIMENT

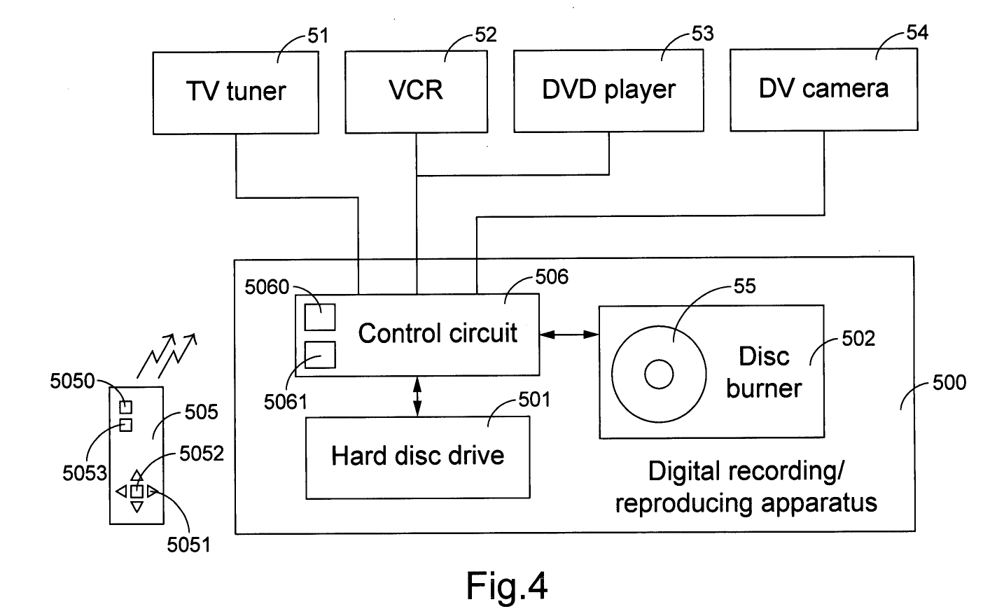

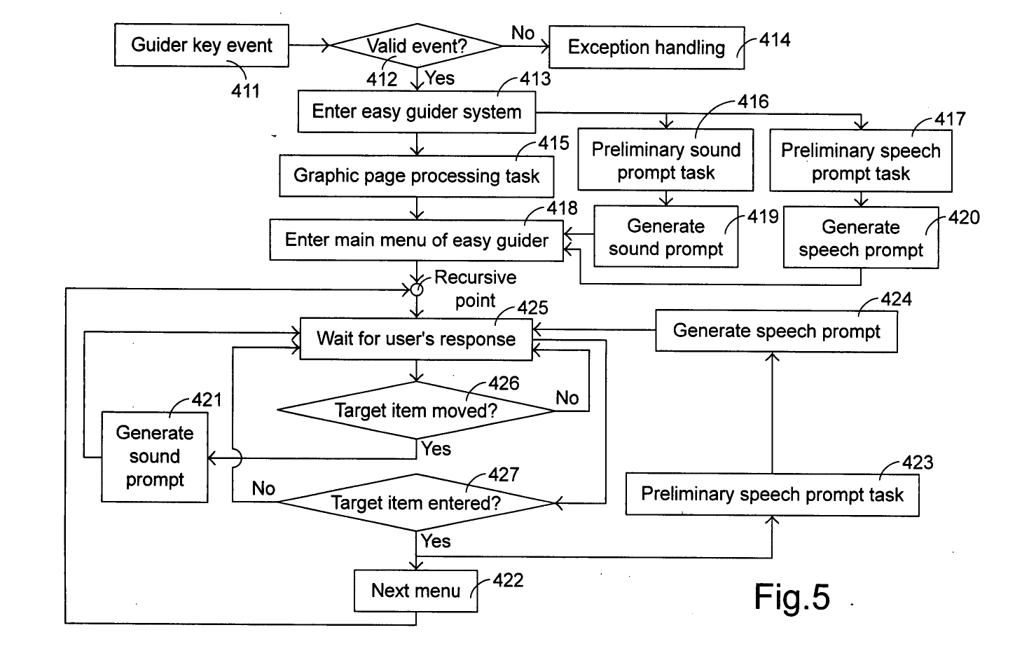

Hereinafter, an embodiment of an auxiliary operation interface and the operation of the auxiliary operation interface for facilitating a user to operate a digital recording/reproducing apparatus according to the present invention will be illustrated with reference to FIG. 4 and FIG. 5.

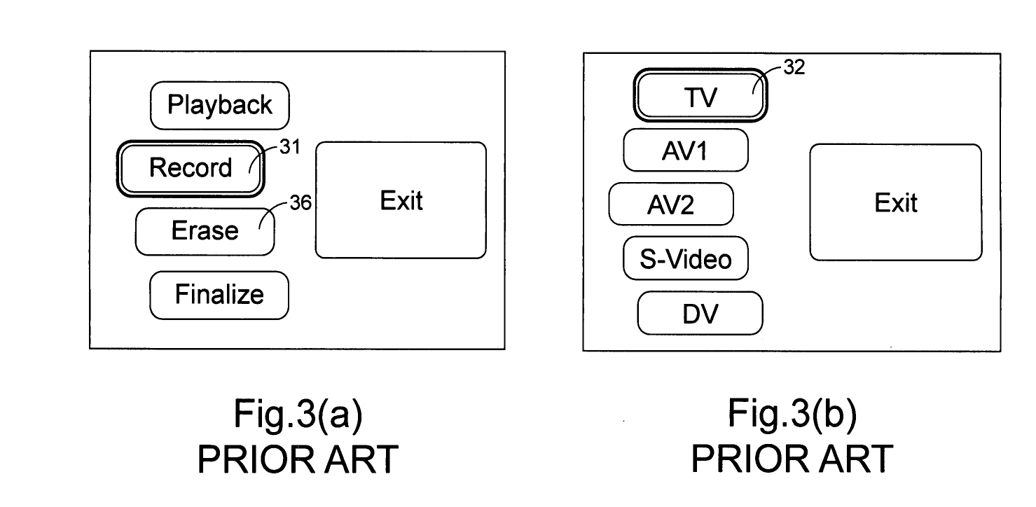

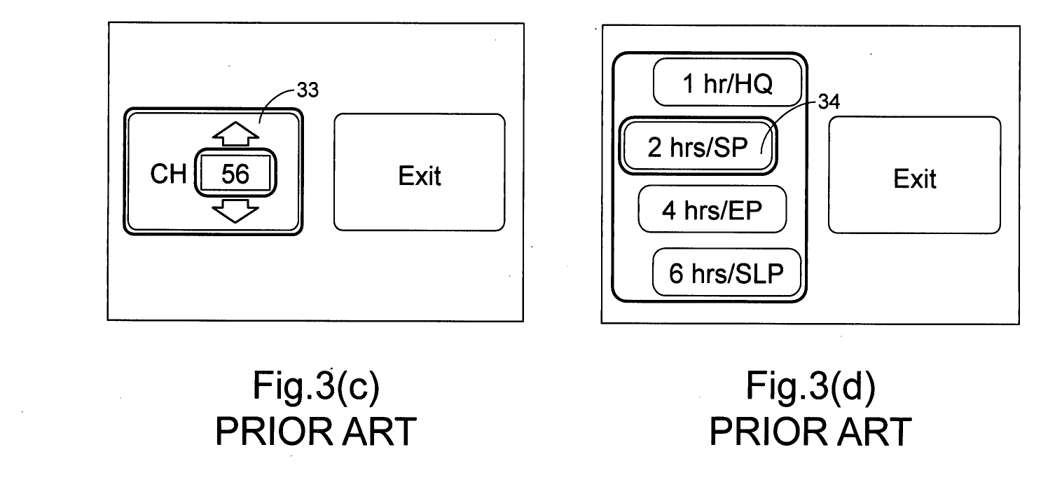

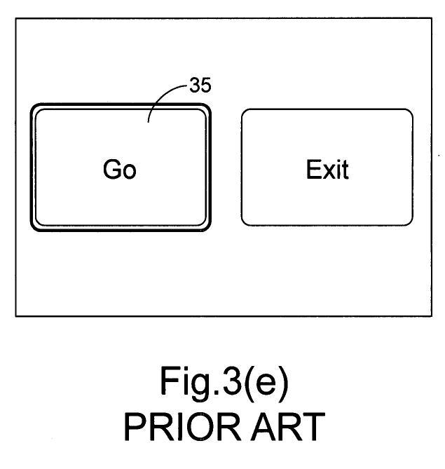

The auxiliary operation interface is used with a digital recording/reproducing apparatus 500 that comprises a disc burner 502, a control circuit 506 and a digital data storage device such as a hard disc drive 501. For recording data from an external source to a disc, the data signals received from the TV tuner 51, the VCR 52, the DVD player 53 or the DV camera 54 are firstly converted into digital data in a specified format such as MPEG by the control circuit 506. The MPEG digital data are then stored in the hard disc drive 501 in an editable manner. Afterwards, the edited digital data can be recorded into the recordable disc 55 by the disc burner 502. On the other hand, it is also possible to record the data previously stored in the disc 55 into the hard disc 501. The auxiliary operation interface includes a guiding menu shown on a screen such as those shown in FIGS. 3(a)˜3(e), a remote controller 505 in wireless communication with the digital recording/reproducing apparatus 500 for cooperating with the guiding menu, and an audio prompt generator implemented by integrated circuits consisting of an audio process engine 5060 and a speech engine 5061 disposed in the control circuit 506 of the digital recording/reproducing apparatus 500. The audio and/or speech prompts generated by the audio prompt generator help the user clearly understand what procedure is proceeding and how to make selection. Each of the audio process engine 5060 and the speech engine 5061 can be implemented with a flash memory or hard disc drive storing a plurality of audio files.

First of all, referring to the flowchart of FIG. 5, by pushing an actuating button 5050 of the remote controller 505, a guider key event occurs (Step 411). If the guider key event is checked by the control circuit 506 and determined to be valid (Step 412), an easy guider system operation procedure is entered (Step 413). Otherwise, the guider key event is invalid and processed by an exception handling procedure (Step 414). In the system operation procedure, a graphic page processing task (Step 415), a preliminary sound prompt task (Step 416) and a preliminary speech prompt task (Step 417) are executed. After the graphic page processing task is performed, a main menu of the easy guider exemplified in FIG. 3(a) as a guiding menu is entered (Step 418) and displayed on the screen (not shown) coupled to the digital recording/reproducing apparatus 500. There are a plurality of selective items, e.g. playback, record, erase and finalize, included in the guiding menu. Meanwhile, the preliminary sound prompt task and preliminary speech prompt task are executed with an application program to locate pre-stored sound and speech data corresponding to the main menu and associated selective items according to respective identifying codes. Then, the located sound and speech data are processed into associated sound and speech prompts by the audio process engine 5060 and the speech engine 5061, respectively (Step 419 and Step 420). In a specific example, while entering the main menu, a speech prompt is outputted for describing the options of user through the main menu. Then, the user can make his selection. When the up/down/left/right selection buttons 5051 of the remote controller 505 are selectively manipulated to lock one of the selective items as a targeting item, a sound prompt is outputted to notify the switching of the targeting item (Step 421). For example, when the user triggers the “up” button of the remote controller 505 to switch the targeting item from the “Erase” key 36 into the “Record” key 31 as currently shown in FIG. 3(a), a sound prompt is outputted simultaneously. Optionally, a speech prompt can also be outputted to repeat the word “Record” or describe what the record key means and/or how it works, depending on the manufacturer's design. By pushing the “Enter” button 5052 of the remote controller 505, the targeting item “Record” is entered. Then, next menu is shown on the screen as another guiding menu (Step 422), e.g. that shown in FIG. 3(b). Meanwhile, a preliminary speech prompt task is executed (Step 423) and a speech prompt for describing the currently displayed menu is generated (Step 424). Likewise, the user can make his further selection through this menu (Steps 425, 426, 427) with the aid of audio and/or speech prompts (Step 421) and trigger another targeting item to enter next menu (Step 422) with the speech prompt describing the next menu for further selection (Steps 423, 424).

An example that a record function is to be executed is used herein to help with the understanding of the auxiliary operation interface according to the present invention. After the main menu of the easy guider system is entered, the highlight cursor should be moved to the desired visual key 31 as shown in the main menu of FIG. 3(a) with the selection button 5051 to lock the item “Record” as the targeting item. During the above procedure, the audio process engine 5060 generates a sound prompt whenever the targeting item changes, i.e. the highlighted cursor changes. Once the item “Record” is locked, the “Enter” button 5052 of the remote controller 505 is pressed down so that the recording function is selected. Then, the sub-menu of FIG. 3(b) is shown for further selection, and the speech engine 5061 generate a speech prompt associated with the contents of this menu. For example, the speech prompt can be “For recording, please select a video source among TV, AV1, AV2, S-Video and DV”. Of course, the speech prompt can be any other language that is available from the pre-stored speech data file or can be downloaded from the Internet. Preferably, a language selection key (not shown) is arranged in the guiding menu and/or a language selection button (not shown) is disposed in the remote controller to achieve this purpose. If the TV video source is selected as the targeting item by moving the highlight cursor to the desired visual key 32 on the screen with the up/down selection button 5051 and entered by pushing the “Enter” button 5052 of the remote controller 505, a further menu will be shown for the user to select the channel that is to be recorded, as shown in FIG. 3(c). Meanwhile, the speech engine 5061 will generate a speech prompt, for example “For recording, please select a TV channel as the video source”. By pushing the channel up/down buttons, the digits in the visual key 33 will change. After the desired channel is located, push “Enter” to enter next menu, as shown in FIG. 3(d). Meanwhile, the speech engine 5061 will generate a speech prompt, for example “For recording, please select the recording quality and the recording period”. After the user selects the desired recording period/quality, e.g. 2 hrs/SP, via the visual key 34 and then pushes the “Enter” button of the remote controller, the frame as shown in FIG. 3(e) will be shown. Meanwhile, the speech engine 5061 will generate a speech prompt, for example “For recording, please press Go to start”. After the user pushes the “Enter” button of the remote controller, the record operation starts.

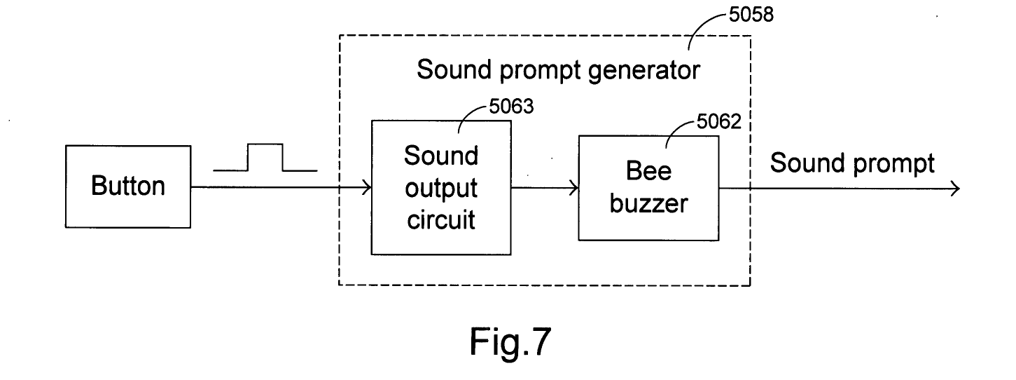

Moreover, an audio prompt can be generated when the digital recording/reproducing apparatus is powered on to indicate the current status of the recording/reproducing apparatus. Ideally, the shift of the targeting item and the switching of the guiding menu are revealed on the display immediately upon the corresponding buttons of the remote controller are pushed. Sometimes, however, the frame change on the screen is not as quick as expected so that whether the button of the remote controller is successfully triggered cannot be confirmed. Therefore, in addition to the sound and/or speech prompts generated by the audio process engine 5060 and/or speech engine 5061 when the digital recording/reproducing apparatus 500 is powered on and whenever the shift of the targeting item and the switching of the guiding menu are executed, as shown in FIG. 5, it is preferred that sound prompts can also be emitted in response to the effective triggering of the button of the remote controller. For confirming that the triggering of the button is effective, the remote controller 505 according to the present invention further comprises a sound prompt generator 5058 (see FIG. 7). When any button of the remote controller 505 is pressed down, a triggering signal is transmitted to the sound prompt generator 5058. In response to the triggering signal, the sound prompt generator 5058 generates a sound prompt to acknowledge the triggering of that button. The sound prompt generator 5058 may comprise a loudspeaker or bee buzzer 5062 to achieve this purpose. Depending on the manufacturer's design, the sound prompt generator 5058 can further comprise a sound output circuit 5063 to generate sound prompts varying with different triggering signals. For example, in response to the triggering signals from a functional button and from a numerical button, the sound prompts emitted from the loudspeaker or bee buzzer are distinguishable. Of course, the sound prompts can also be replaced with speech prompts, depending on manufacturer's design.

The above-mentioned sound prompts and the speech prompts, no matter if it is generated by the prompt generator in the digital recording/reproducing apparatus 500 or the remote controller 505, may be selected from several preset audio files. Alternatively, the audio files can be downloaded from a designated website via the Internet. For example, the audio files include speech prompts of different languages.

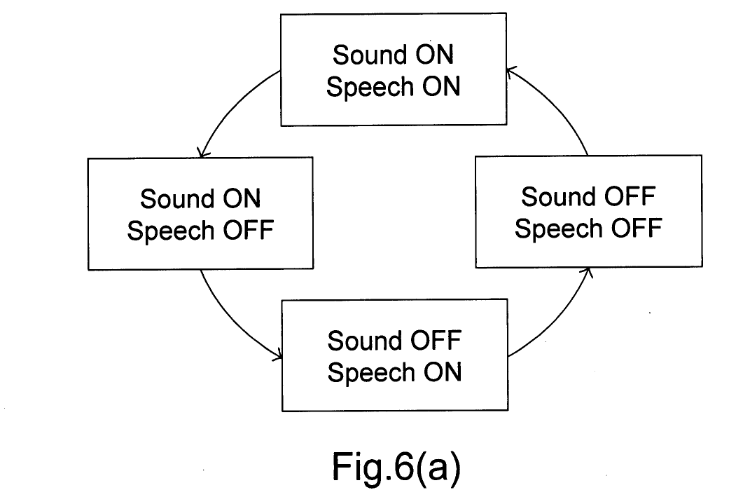

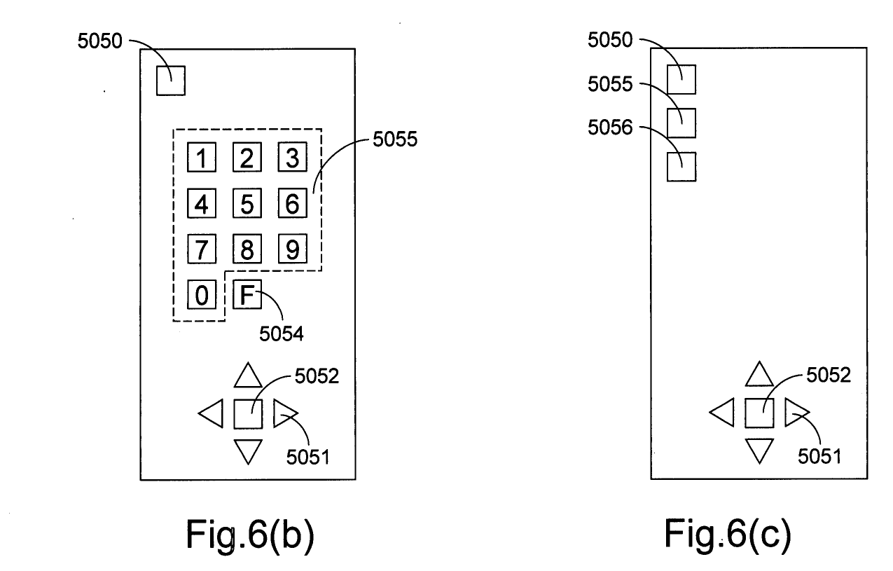

It is understood from the above description that the auxiliary operation interface capable of generating audio prompts according to the present invention facilitates the operation of the digital recording/reproducing apparatus. Nevertheless, the audio prompt function can be shut off when it is not necessary any more and restored at any time. Via the speech/sound prompt switching button 5053 of the remote controller, the audio process engine 5060 and the speech engine 5061 that respectively generate sound prompts and speech prompts can be selectively and independently enabled and/or disabled for example according to the sequence shown in FIG. 6(a). In this example, the audio process engine 5060 and the speech engine 5061 are both enabled upon the actuating button 5050 of the remote controller 505 is pressed down to trigger a guider key event, i.e. upon the easy guider is entered. Once the switching button 5053 is pressed down, the speech engine 5061 is disabled but the audio process engine 5060 remains enabled. One more push of the switching button 5053 disables the audio process engine 5060 but enables the speech engine 5061. Subsequently, once the switching button 5053 is pressed down again, the audio process engine 5060 and the speech engine 5061 are both disabled. The switching cycle will be repeated by repetitively triggering the switching button 5053. Instead of using the single switching button 5053 to switch phases as described above, the similar selectively enabling and/or disabling functions can also be practiced by pushing a combination of buttons, each single one of which has been programmed for another function. For example, as shown in FIG. 6(b), a user may push a functional button 5054 and one of four designated numerical buttons 5055 as a combination to differentially enable and/or disable the sound/speech prompts. Alternatively, the similar selectively enabling and/or disabling functions can be practiced by pushing respective exclusive buttons. For example, as shown in FIG. 6(c), the single switching button 5053 of the remote controller 505 can be replaced by a sound prompt switching button 5055 and a speech prompt switching button 5056 for selectively enabling or disabling the sound effect and speech effect.

From the above description, the auxiliary operation interface of the present invention is advantageous for facilitating a user to operate a digital recording/reproducing apparatus with the aid of the sound/speech prompts. In addition, whenever the shift of the targeting item and the switching of the guiding menu are executed, the remote controller of the present invention emits an audio prompt in response to the effective triggering of the button thereof. Accordingly, the problem in erroneously repetitively pushing the same button can be overcome.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A remote controller for use with a digital recording/reproducing apparatus, comprising:
at least a button for cooperating with said digital recording/reproducing apparatus; and
an audio prompt generator for generating an audio prompt;
wherein said audio prompt generator generates said audio prompt in response to a triggering operation done on said button.

2. The remote controller according to claim 1 wherein said audio prompt generator further comprises a loudspeaker.

3. The remote controller according to claim 1 wherein said audio prompt generator further comprises a bee buzzer.

4. The remote controller according to claim 1 wherein a triggering signal is issued to said audio prompt generator in response to said triggering operation, and said audio prompt generator generates said audio prompt in response to said triggering signal.

5. The remote controller according to claim 4 wherein said audio prompt generator includes a sound output circuit for varying audio prompts according to said triggering signal.

6. A remote controller for use with a digital recording/reproducing apparatus, comprising:
a plurality of selection buttons for cooperating with said digital recording/reproducing apparatus to select a targeting item;
a confirmation button for having said digital recording/reproducing apparatus execute a selected function corresponding to said targeting item; and
an audio prompt generator generating an audio prompt;
wherein said audio prompt generator generates said audio prompt in response to a triggering operation done on one of said selection buttons and said confirmation button.

7. The remote controller according to claim 6 further comprising a loudspeaker or a bee buzzer.

8. An auxiliary operation interface for use with a digital recording/reproducing apparatus, comprising:
a guiding menu having a targeting item optionally triggered to have said digital recording/reproducing apparatus execute a selected function;
a first audio prompt generator enabled to generate a first audio prompt when said targeting item is triggered to enter said selected function; and
a remote controller comprising:
a plurality of buttons for manipulating said targeting item; and
a second audio prompt generator for generating a second audio prompt when any of said buttons is pushed.

9. The auxiliary operation interface according to claim 8 wherein said second audio prompt generator includes a sound output circuit for varying said second audio prompt with the pushed button.

10. The auxiliary operation interface according to claim 8 wherein said guiding menu is entered with a function button of said remote controller.

11. The auxiliary operation interface according to claim 8 wherein said guiding menu further comprises a plurality of selective items, and said selected function is entered by switching said targeting item to selectively lock one of said selective items by using said buttons of said remote controller.

12. The auxiliary operation interface according to claim 8 wherein said targeting item is triggered with an enter button of said remote controller.

13. The auxiliary operation interface according to claim 10 wherein said first audio prompt generator is enabled and disabled with a switching button set of said remote controller.

14. The auxiliary operation interface according to claim 13 wherein said switching button set of said remote controller includes a single button or a combination of buttons.

15. The auxiliary operation interface according to claim 8 wherein said second audio prompt generator includes a loudspeaker or a bee buzzer.

16. The auxiliary operation interface according to claim 8 wherein said first audio prompt generator includes an audio process engine and/or a speech engine.

17. The auxiliary operation interface according to claim 8 wherein said first audio prompt generator includes a flash memory or hard disc drive for storing a plurality of audio files.

18. The auxiliary operation interface according to claim 8 wherein said first audio prompt generator is implemented by integrated circuits for generating said first audio prompt.
